(19) United States
(12) Patent Application Publication
(10) Pub. No.: US 2014/0003456 A1
(43) Pub. Date: Jan. 2, 2014

(54) Device For Converting The Profile of a Laser Beam Into a Laser Beam With a Rotationally Symmetrical Intensity Distribution

(71) Applicants: Iouri Mikliaev, Cheljabinsk (RU); Jens Meinschien, Dortmund (DE); Thomas Mitra, Dortmund (DE)

(72) Inventors: Iouri Mikliaev, Cheljabinsk (RU); Jens Meinschien, Dortmund (DE); Thomas Mitra, Dortmund (DE)

(73) Assignee: LIMO Patentverwaltung GmbH & Co.KG, Dortmund (DE)

(21) Appl. No.: 13/978,866

(22) PCT Filed: Jan. 10, 2012
(86) PCT No.: PCT/EP2012/050310

§ 371 Date: Sep. 18, 2013

(30) Foreign Application Priority Data
Jan. 10, 2011 (DE) 10 2011 008 192.5

(51) Int. Cl. G02B 27/09

(52) U.S. Cl. CPC G02B 27/0927
USPC 372/29.014

(57) ABSTRACT

The invention relates to a device for transforming the profile of a laser beam (5) into a laser beam (5) with a rotationally symmetrical intensity distribution such as an M-profile or a rotationally symmetrical top-hat profile, said device comprising at least one lens array (1) with at least two lenses (5) through which the laser beam (5) that is to be transformed can pass, and optical means which can direct the laser beam (5) that has passed through the at least one lens array (1) onto a working plane (3) and/or superimpose at least some sections of said laser beam on the working plane (3), the lenses (7) of the at least one lens array (1) being arranged coaxially or concentrically with respect to one another.

The present invention relates to a device for transforming the profile of a laser beam into a laser beam having a rotationally symmetrical intensity distribution according to the preamble of claim 1 or according to the preamble of claim 13.

### DEFINITIONS

Propagation direction of the laser beam refers to an average propagation direction of the laser beam, in particular when the laser beam is not a plane wave or is at least partly diverging. Unless expressly stated otherwise, laser beam, light beam, sub-beam, or beam does not refer to an idealized beam of the geometrical optics, but to a real light beam, such as a laser beam, which does not have an infinitely small beam cross-section, but rather an extended beam cross-section. M-distribution or M-intensity distribution or M-profile refers to an intensity profile of a laser beam wherein the intensity in the center of the cross section is lower than in one or more off-center areas. Top-hat distribution or top-hat intensity distribution or top-hat profile refers to an intensity distribution, which can be substantially described in at least one direction by a rectangular function (rect (x)). Real intensity distributions having deviations from a rectangular function In the range of percents or having sloped edges will also be referred to as a top-hat distribution or top-hat profile.

An apparatus of the aforementioned type is, for example, known from U.S. 2004/0161676 A1. The device described in this document includes an optical system used to illuminate an amplitude-modulation mask with laser beam. The light emerging from the mask is imaged by another optical system onto a phase shift mask. The light emerging from this mask is imaged by another optical system onto a substrate to be illuminated in a working plane. On this substrate, the laser beam has perpendicular to the propagation direction an annular intensity distribution which can be referred to as M-profile.

However, disadvantageously, the construction of the device is complicated and expensive. Furthermore, the use of the masks causes losses which may be significant under certain circumstances.

The problem underlying the present invention is thus to provide a device of the aforementioned type which has a simpler and more effective design.

This object is attained according to the present invention with a device of the aforementioned type having the characterizing features of claim 1 or of claim 13. The dependent claims relate to preferred embodiments of the invention.

According to claim 1, the lenses of the at least one lens array may be arranged coaxially and concentrically with respect to each other. With such a configuration, a laser beam can be readily and effectively transformed into laser beam with an M-profile or with a rotationally symmetrical top-hat profile. In this case, a device according to the invention is not only capable of transforming laser beam with a Gaussian profile, but laser beam with any type of rotationally symmetrical profile into an M-shaped profile or a rotationally symmetrical top-hat profile. In particular, the laser beam emitted from an optical fiber of a multimode laser can be transformed into a desired rotationally symmetrical intensity distribution having, for example, an M-profile or a rotationally symmetric top-hat profile.

Such device can be used for pumping solid state lasers or material processing. In particular in materials processing, an intensity distribution with an M-profile can lead to uniform processing due to heat conduction.

For example, the lenses of the at least one lens array may be arranged coaxially with respect to the optical axis of the at least one lens array. In particular, the optical axis of the at least one lens array may be oriented parallel to the propagation direction of laser beam.

Accordingly, at least a first of the lenses may have an annular shape, in particular the shape of a circular ring, and at least a second of the lenses may have an annular shape, in particular the shape of a circular ring, wherein the diameter of the first lens is smaller than the diameter of the second lens. The lenses thus form, for example, a system of concentric rings.

At least a first of the lenses and at least a second of the lenses may be made of mutually different materials. This allows greater latitude in the design of the lens array.

The optical means may include at least one lens which is arranged in the device in such a way that the at least one lens array is disposed in the input-side focal plane and the working plane is disposed in the output-side focal plane of the lens, This creates a Fourier configuration, wherein the angular distribution of the laser beam emerging from the at least one lens array is transformed into an intensity distribution in the working plane.

Each lens may be shaped or configured so as to generate an angular distribution corresponding to the desired radial intensity distribution in the far field. The device may be configured such that a plurality of intensity distributions, which each have already the desired shape, are superimposed to form a common intensity distribution.

Alternatively, the lenses may be shaped or configured so as to each produce an angular distribution which does not correspond to the desired radial intensity distribution in the far field. The device may be configured such that the desired radial intensity distribution is produced only by superimposing the individual partial beams.

The device may have two lens arrays, each having at least two lenses, wherein the laser beam emitted by the laser light source may first pass through the first lens array and thereafter pass through the second lens array, wherein the optical means may introduce the laser beam that had passed through the second lens array into a working plane and/or at least partially superimpose that laser beam in the working plane.

According to claim 13, the mirrors of the at least one mirror array are arranged coaxially and concentrically with respect to one another. This results in a design similar to the design according to claims 1 to 12, wherein the laser beam is substantially transformed not by refraction, but by reflection.

Small incident and exit angles may occur on the mirrors, for example, of less than 30°, in particular less than 20° from the normal.

Further features and advantages of the present invention will become apparent from the following description of preferred embodiments with reference to the appended drawings, which show in

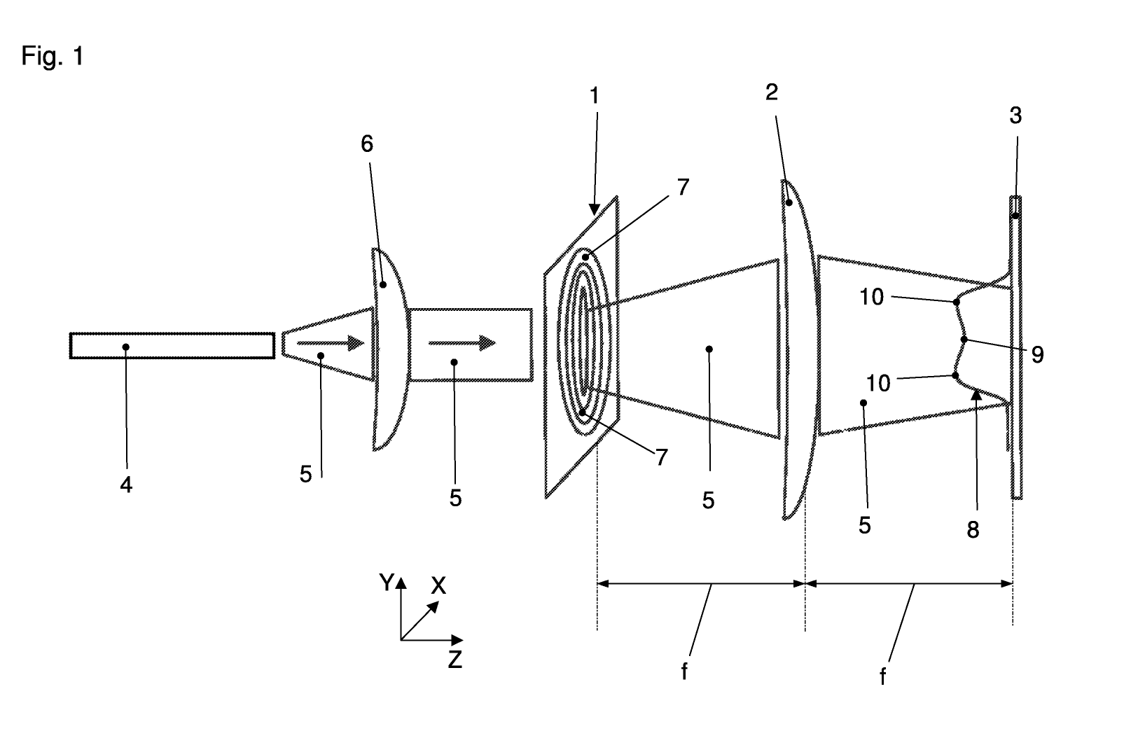

FIG. 1 a schematic perspective view of a device according to the invention;

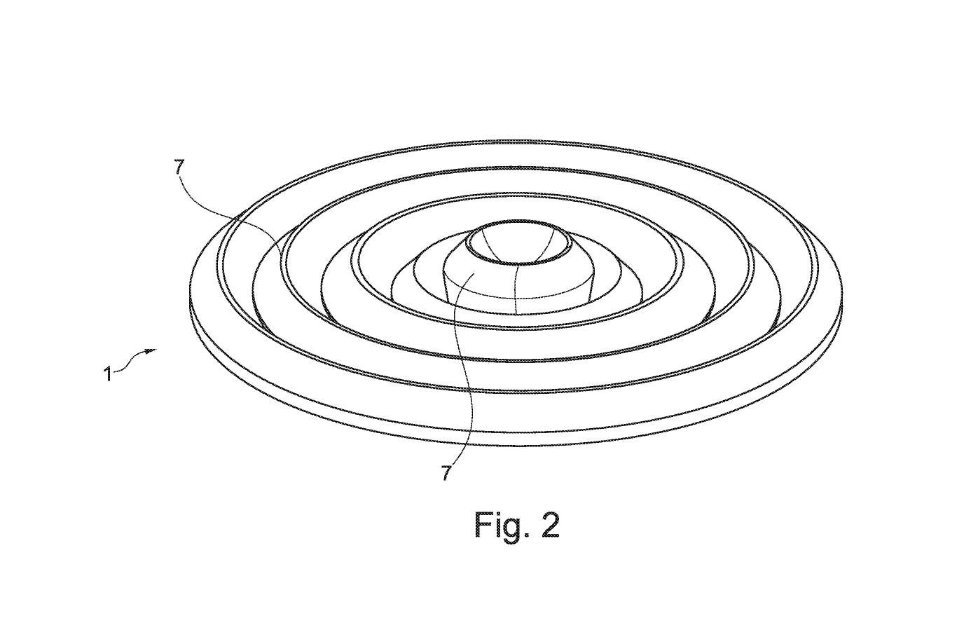

FIG. 2 a 3D model of an embodiment of the lens array of the device; and

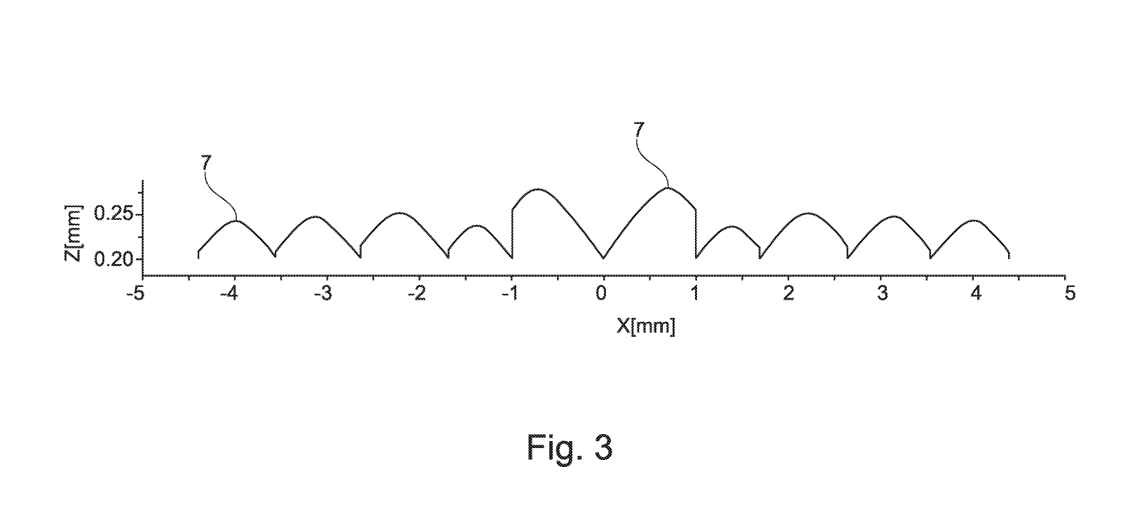

FIG. 3 a cross section through the lens array with an exemplary design of the surface structure of the lenses.

A Cartesian coordinate system is shown in FIG. 1 for the purpose of illustration.

The illustrated device includes a lens array 1 and a lens 2 in a Fourier configuration. The distance between the lens 2 and the lens array 1 in the Z-direction and the distance between the lens 2 and a working plane 3 extending in an X-Y plane in the Z direction each correspond to the focal length f of the lens 2.

The end of an optical fiber 4 serves as the laser light source. The laser light 5 propagating through the optical fiber 4 may be generated from any type of laser. The laser beam 5 emanating from the optical fiber 4 in the positive Z direction is collimated by schematically illustrated collimation means 6. The collimation means 6 may in the simplest case, as shown in FIG. 1, be formed as a plano-convex spherical lens.

The collimation means may be omitted or designed differently, so that the laser beam is not collimated.

In the illustrated embodiment, this collimated laser light 5 is incident on the lens array 1. The lens array 1 is aligned parallel to an X-Y plane and includes a plurality of lenses 7, which surround the optical axis of the lens array 1 as concentric rings. The optical axis of the lens array 1 may be parallel to the Z-direction and hence parallel to the average propagation direction of the collimated laser beam 5.

The lenses 7 may have convex, concave or alternating convex and concave shapes. The distances, radii and thicknesses of the lenses 7 may be largely freely selected. The lens shape is selected so that the desired radial intensity distribution is generated in the far field. In general, the shape of the lenses 7 is preferably aspherical. FIGS. 2 and 3 illustrate exemplary embodiments of the lens array 1.

Polynomials may be generated by suitable optimization methods, which depend on the specific boundary conditions such as refractive index, numerical aperture and radii of the annular lenses 7. The surface structure may be computed separately from these polynomials for each annular lens 7. The surface of the lens array 1 will therefore be in general a rotationally symmetric free-form surface.

However, graded-index (GRIN) lenses may also be used as lenses 7.

After passing through the lens array 1, the laser radiation 5 has an angular distribution representing the angular distribution of an M-shaped profile. This angular distribution is transformed by the lens 2 into an intensity distribution 8 in the working plane 3, as schematically indicated in FIG. 1. The intensity distribution 8 shows of a typical M-distribution with a local minimum 9 in the center and with two further outwardly adjoining local maxima 10.

The lenses 7 of the lens array 1 may be designed so as not to produce an M-profile, but instead a rotationally symmetrical top-hat profile. However, other profiles may be produced with a suitable design of the lenses 7, for example a rotationally symmetric profile having a peak and long edges. Such profile may be different from a Gaussian profile in that the central maximum is significantly more pointed.

In particular, each of the lenses 7 may be shaped or configured so as to generate an angular distribution that corresponds to the desired radial intensity distribution in the far field. This plurality of angular distributions with the desired radial profile is transformed by the lens 2 into the desired radial intensity distribution in the working plane 3, wherein a plurality of intensity distributions, each of which has already the desired shape, may here be superimposed to form a common intensity distribution.

Alternatively, the lenses 7 may be formed or shaped so that they each produce an angular distribution which does not correspond to the desired radial intensity distribution in the far field. Rather, the desired radial intensity distribution is produced here only by superimposing the individual partial beams.

The individual lenses 7 may be made of different materials. Thus, for example, one of the first lenses 7 may be made of a first material and a second of the lenses 7 may be made of a second material.

Moreover, two lens arrays arranged sequentially in the propagation direction of the laser beam 5 may be provided, both of which are disposed between the laser light source and the lens 2 used as a Fourier lens. In this manner, a two-stage homogenization can be achieved. The lens array representing the first stage can then prevent an excessively high intensity to be applied to or incident on the lens array representing the second stage.

1-23. (canceled)

24. A device for transforming the profile of a laser beam (5) into a laser beam (5) with a rotationally symmetrical intensity distribution, such as an M-profile or a rotationally symmetric top-hat profile, comprising
at least one lens array (1) having at least two lenses (7), through which the laser beam (5) to be transformed can pass, and
optical means which introduce the laser beam (5) that has passed through the at least one lens array (1) into a working plane (3) and/or to at least partially overlap that laser beam (5) in the work plane (3),
wherein the lenses (7) of the at least one lens array) are arranged coaxially and concentrically with respect to one another.

25. The device according to claim 24, wherein the lenses (7) of the at least one lens array (1) are arranged coaxially with respect to the optical axis of the at least one lens array (1).

26. The device according to claim 25, wherein the optical axis of the at least one lens array (1) is parallel to the propagation direction of the laser beam (5).

27. The device according to one of claims 24, wherein at least a first of the lenses (7) has an annular shape.

28. The device according to claim 27, wherein at least a second of the lenses (7) has an annular shape, and wherein the diameter of the first lens (7) is smaller than the diameter of the second lens (7).

29. The device according to claim 24, wherein at least a first of the lenses (7) and at least a second of the lenses (7) is made of mutually different materials.

30. The device according to claim 29, wherein the optical means comprise at least one lens (2) which is arranged in the device such that the at least one lens array (1) is arranged in the input-side focal plane and the working plane (3) arranged in the output-side focal plane of the lens (2).

31. The device according to claim 24, wherein each of the lenses (7) is shaped and configured so as to generate an angular distribution that corresponds to the desired radial intensity distribution in the far field.

32. The device according to claim 31, wherein the device is configured such that a plurality of intensity distributions, each already having the desired shape, are superimposed to form a common intensity distribution.

33. The device according to claim 24, wherein the lenses (7) are shaped configured such that they each produce an angular distribution which does not correspond to the desired radial intensity distribution in the far field.

34. The device according to claim 33, wherein the device is configured such that the desired radial intensity distribution of is produced only by superimposing the individual partial beams.

35. The device according to claim 24, wherein the device comprises two lens arrays (1), each having at least two lenses (7), wherein the laser beam (5) emanating from the laser light source can first pass through the first lens array (1) and then pass through the second lens array, wherein the optical means can introduce the laser beam (5) which has passed through the second lens array into a working plane (3) and/or at least partially superimpose the laser beam (5) in the working plane (3).

36. A device for transforming the profile of a laser beam (5) into a laser beam (5) with a rotationally symmetrical Intensity distribution, such as an M-profile or a rotationally symmetric top-hat profile, comprising
at least one mirror array with at least two mirrors, on which the laser beam (5) to be transformed can be reflected, and
optical means which can introduce the laser beam (5) reflected by the at least one mirror array into a working plane (3) and/or at least partially superimpose the reflected laser beam (5) in the working plane (3), wherein the mirrors of the at least one mirror array are arranged coaxial and concentrically with respect to one another.

37. The device according to claim 36, wherein the mirrors of the at least one mirror array are arranged coaxially with respect to the optical axis of the at least one mirror array.

38. The device according to claim 37, wherein the optical axis of the at least one mirror array is parallel to the propagation direction of the laser beam (5).

39. The device according to one of claims 36, wherein at least a first of the mirrors has an annular shape, in particular a shape of a circular ring.

40. The device according to claim 39, wherein at least a second of the mirrors has an annular shape, in particular a shape of a circular ring, wherein the diameter of the first mirror is smaller than the diameter of the second mirror.

41. The device according to one of claims 36, wherein the reflective surface of at least a first of the mirrors and the reflective surface of at least a second of the mirrors is made of mutually different materials.

42. The device according to one of claims 36, wherein each of the mirrors is shaped and configured so as to generate an angular distribution that corresponds to the desired radial intensity distribution in the far field.

43. The device according to claim 42, wherein the device is configured such that a plurality of intensity distributions that each have already the desired shape are superimposed to form a common intensity distribution.

44. The device according to claim 36, wherein the mirrors are formed or configured so as to each produce an angular distribution that does not correspond to the desired radial intensity distribution in the far field,

45. The device according to claim 44, wherein the device is configured such that the desired radial intensity distribution is attained only by superimposing the individual partial beams.

46. The device according to claim 36, wherein the device comprises two mirror array having at least two mirrors, wherein the laser beam (5) emanating from the laser light source can be reflected first on the first mirror array and thereafter be reflected on the second mirror array, wherein the optical means can introduce the laser beam (5) reflected on the second mirror array into a working plane (3) and/or at least partially superimpose the reflected laser beam (5) in the work plane (3).

47. The device according to claim 24, wherein the at least a first of the lenses (7) has a shape of a circular ring.

48. The device according to claim 27, wherein the at least a second of the lenses (7) has a shape of a circular ring.
